(19) United States
(12) Patent Application Publication
(10) Pub. No.: US 2007/0136490 A1
(43) Pub. Date: Jun. 14, 2007

(54) Wireless hub and data store

(75) Inventor: Brandon Freitag, Wheaton, IL (US)

Correspondence Address: MCDONALD HOPKINS CO., LPA, 600 SUPERIOR AVE., E., SUITE 2100, CLEVELAND, OH, 44114, US

(73) Assignee: Oracle International Corporation, Redwood Shores, CA (US)

(21) Appl. No.: 11/302,858

(22) Filed: Dec. 14, 2005

(51) Int. Cl. G06F 15/173

(52) U.S. Cl. 709/238

(57) ABSTRACT

Systems, methods, media, and other embodiments associated with a personal wireless hub and data store are described. One exemplary system embodiment includes logic for wireless communication to a very local area network. The example system also includes a memory configured to store data for devices on the very local area network and logic for managing the stored data.

### BACKGROUND

Personal electronic devices come in a variety of shapes and sizes and perform a variety of actions. Thus, an individual may carry several personal electronic devices at one time. For example, a person may carry a cellular telephone, an MP3 player, a personal digital assistant (PDA), a smart pay device (e.g., gasoline card), a laptop computer, a digital camera, a personal movie viewer, and so on. Typically, each of these devices has been a stand alone device that assumes that it is responsible for all of its own needs. Thus, each of these devices has typically had its own circuitry (e.g., memory) for storing data and software for manipulating (e.g., storing, securing, sharing) data. Similarly, to the extent that each of these devices has communicated, they have typically had their own circuitry (e.g., radio) for wireless communication and software for controlling the use of the circuitry (e.g., initiating communication, securing communication, transferring data, terminating communication). Therefore, a person could easily have found themselves in a situation where they are carrying five radios and five memories. Each of the radios may have performed substantially the same function and each of the memories may have stored potentially overlapping data. This was inefficient in terms of weight carried, space consumed, batteries required, and power consumed.

Some devices have begun to emerge to address at least some of the issues associated with carrying multiple devices. For example, personal wireless hubs have appeared that allow personal electronic devices to have shorter range special purpose communication circuits that communicate with the personal wireless hub via a very local area network. The personal wireless hub may also have been configured to communicate with the wider world through protocols like Bluetooth, cellular telephony, IEEE 802.11, and so on. These devices have at least partially addressed the duplicate radio issue associated with carrying multiple personal electronic devices. However, these personal wireless hubs have been almost exclusively directed towards removing redundancy in communication hardware.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that unless otherwise stated, one element may be designed as multiple elements, multiple elements may be designed as one element, an element shown as an internal component of another element may be implemented as an external component and vice versa, and so on. Furthermore, elements may not be drawn to scale.

FIG. 1 illustrates an example personal wireless hub and data store.

FIG. 2 illustrates an example personal wireless hub and data store.

FIG. 3 illustrates an example wireless hub and data store apparatus.

FIG. 4 illustrates an example method associated with a personal wireless hub.

FIG. 5 illustrates an example method associated with a personal wireless hub and data store.

FIG. 6 illustrates an example data packet.

FIG. 7 illustrates an example application programming interface (API) associated with a personal wireless hub and data store.

### DETAILED DESCRIPTION

A personal wireless hub may be configured with a data store. The data store may include circuitry and/or logic that facilitates aggregating, storing, and/or manipulating data associated with personal electronic devices. Additionally and/or alternatively the personal wireless hub may be configured with circuitry and/or logic that controls the data store and therefore facilitates aggregating, storing, and/or manipulating the personal data. Thus, personal electronic devices configured to interact with the personal wireless hub and data store may have smaller memories and may depend on the data store to store data on their behalf. In one example, the personal electronic devices may depend on the personal data store to secure data, to organize data, to synchronize data with other devices and/or a database, and so on. In one example, the wireless hub data store may be configured as a relational database.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, software in execution, or a combination thereof. For example, a computer component can be a process running on a processor, a processor, an object, an executable, a thread of execution, a program, a computer, and so on. By way of illustration, both an application running on a server and the server can be computer components. One or more computer components can reside within a process and/or thread of execution and a computer component can be localized on one computer and/or distributed between two or more computers.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, semiconductor memories, dynamic memory and the like. Transmission media can take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. In different examples a data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities including a processor, operating system, circuit, logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, computer component, logic, and/or other electronic device to perform functions, actions and/or behave in a desired manner. The instructions may be embodied in various forms including routines, algorithms, modules, methods, threads, and/or programs including separate applications or code from dynamically linked libraries. Software may be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may depend, for example, on requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus may be loaded and/or executed in serial, parallel, massively parallel and other manners.

Suitable software for implementing various components of example systems and methods described herein may be developed using programming languages and tools (e.g., Java, C, C#, C++, C, SQL, APIs, SDKs, assembler). Software, whether an entire system or a component of a system, may be embodied as an article of manufacture and maintained or provided as part of a computer-readable medium. Software may include signals that transmit program code to a recipient over a network or other communication medium.

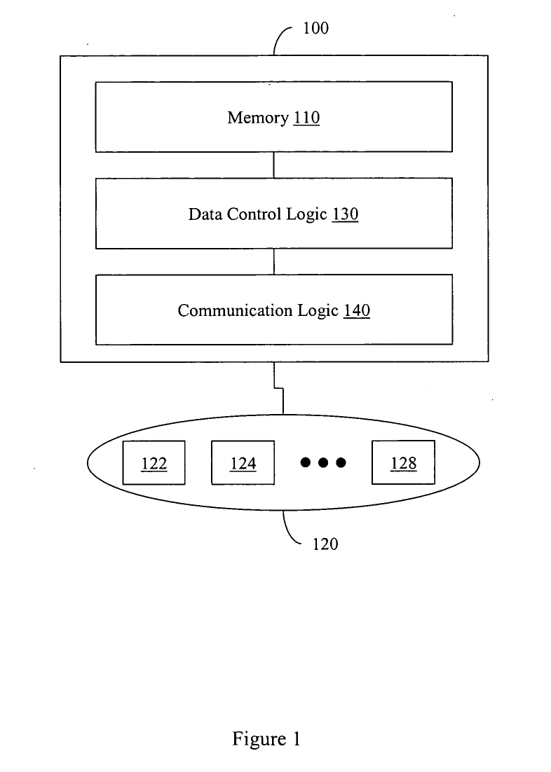

FIG. 1 illustrates an apparatus 100. Apparatus 100 may be referred to as a personal wireless hub and data store. Apparatus 100 may include a memory 110 that is configured to store application data. The application data may be associated with an electronic device(s) (e.g., 122, 124, . . . 128) operating in a very local wireless network 120. Memory 110 is located in a computing device (e.g., apparatus 100) separate from the electronic devices.

The electronic devices may include, for example, a cellular telephone, a PDA, a music player (e.g., MP3 (MPEG audio level 3) player), a video player (e.g., MPEG (Moving Pictures Experts Group) player), and so on. Thus, the application data may include cellular telephone data, PDA data, music, video, and contact data. Typically this data would be stored separately in each device. For example, an MP3 player may have several gigabytes of memory in which songs are stored. Similarly, a cellular telephone may have memory in which ring tones are stored. Some ring tones may have “extended versions” which are in reality an entire song. In one example, the song may be stored in the memory 110 and provided to the MP3 player and/or the cellular telephone “on demand”. Thus, both the MP3 player and the cellular telephone can have smaller memories, which may reduce weight, size, power consumption, and so on.

The wireless hub 100 and the electronic devices may be arranged in a very local wireless network 130. These types of networks may have extremely limited range and thus have very low power. For example, a very local wireless network may span only a few meters (e.g., 2) and thus may operate at a very low power (e.g., 10 milliwatts). In some cases, the wireless hub 100 and the electronic devices may be part of a “wearable computing” outfit where different electronic devices are incorporated into clothing worn by a user.

Apparatus 100 may also include a data control logic 130 that is operably connected to the memory 110. The data control logic 130 may be configured to control how data is stored, managed, and communicated. Thus, the data control logic 130 may both receive application data from the electronic devices and selectively provide application data stored in the memory 110 to the electronic devices. The data control logic 130 may store application data in the memory 110 and may also facilitate manipulating application data stored in the memory 110.

In one example the data control logic 130 may be configured to manage application data stored in the memory 110 to be shareable between electronic devices on the very local wireless network 120. This may facilitate reducing redundancy by storing a single copy of some data (e.g., song, email address) where previously a copy of the same data may have been stored in each device. In another example, the data control logic 130 may be configured to manage application data stored in the memory 110 to be synchronized between electronic devices on the very local wireless network 120. This may simplify managing the very local wireless network 120 and reducing errors caused by out-of-date data. It may also be more straight forward to secure information stored in a single location.

Thus, data control logic 130 may be configured to secure (e.g., encrypt, password-protect, biometric protect) data stored in memory 110. Storing data in memory 110 and accessing that data from electronic devices on wireless network 120 may facilitate implementing a two-stage security system where a first security measure is applied to access an electronic device and a second security measure is applied to access data stored in memory 110. For example, an electronic device may be protected by a password while the wireless hub may be protected biometrically (e.g., fingerprint). This may provide greater security for devices that tend to get misplaced and/or stolen.

Apparatus 100 may also include a communication logic 140 operably connected to the memory 110. The communication logic 140 may be configured to communicate application data between memory 110 and the electronic devices using the very local wireless network 120. Note that apparatus 100 may simply include communication circuits, memory, and logic to run the relational database. There may be no input/output devices (e.g., keyboard), no display unit (e.g., monitor), no audio unit (e.g., speaker) and so on. The input/output capability, audio capability, and display capability may all be provided by devices accessing the wireless hub.

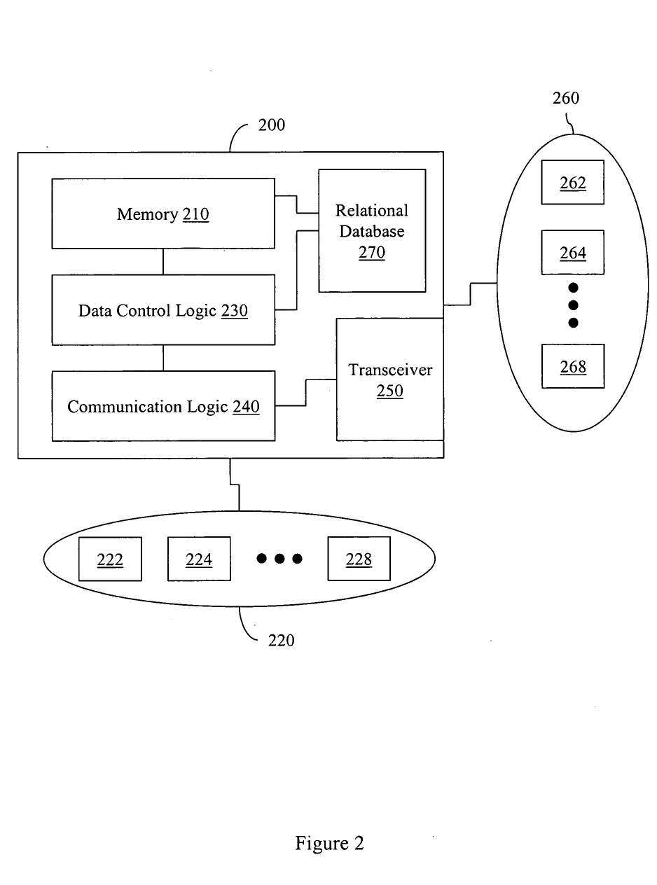

FIG. 2 illustrates an apparatus 200 that is similar to apparatus 100. For example, apparatus 200 includes a memory 210, a data control logic 230, and a communication logic 240 similar to those described in connection with FIG. 1. Similarly, apparatus 200 communicates with electronic device(s) (e.g., 222, 224, . . . 228) operating on a very local wireless network 220.

In apparatus 200, communication logic 240 may additionally be configured to control a transceiver 250 to communicate with a second network 260. Thus, in one example, apparatus 200 may provide both short range communications for devices in the very local wireless network 220 and may also provide longer range communications to other devices (e.g., 262, 264, 268) outside the very local wireless network 220. In this configuration, apparatus 200 may be referred to as a bridge, router, and/or gateway since it facilitates spanning two or more networks. When communication logic 240 is only configured to communicate on very local wireless network 220 then apparatus 200 may be referred to as a hub. Since very local wireless network 220 is wireless, the communication logic 240 may be configured to control a radio transceiver to communicate with the very local wireless network 220.

Network 260 may be, for example, a wireless network. Network 220 and network 260 may have different characteristics since network 220 may be employed primarily for communicating with and/or between personal electronic devices while network 260 may be employed primarily for communicating with other devices (e.g., server) and/or networks (e.g., the Internet). In one example, the very local wireless network 220 may operate at a range of less than two meters. Since the range is so small, the very local wireless network 220 may operate with a power of less than 10 milliwatts. In another example, the second network 260 may operate at a longer range (e.g., more than 100 meters). Since the range is greater, the power may also be greater (e.g., 500 milliwatts).

In apparatus 200, the data control logic 230 may also be configured to manage a relational database 270. While relational database 270 is illustrated external to memory 210, it is to be appreciated that all and/or parts of relational database 270 may be stored in memory 210. Thus, data control logic 230 may interact with relational database tables and may manipulate application data stored in the memory 210 as a portion of the relational database table. In one example, relational database 270 may reside completely on apparatus 200 while in another example a first portion of relational database 270 may reside on apparatus 200 and a second portion of relational database 270 may reside elsewhere (e.g., on a server).

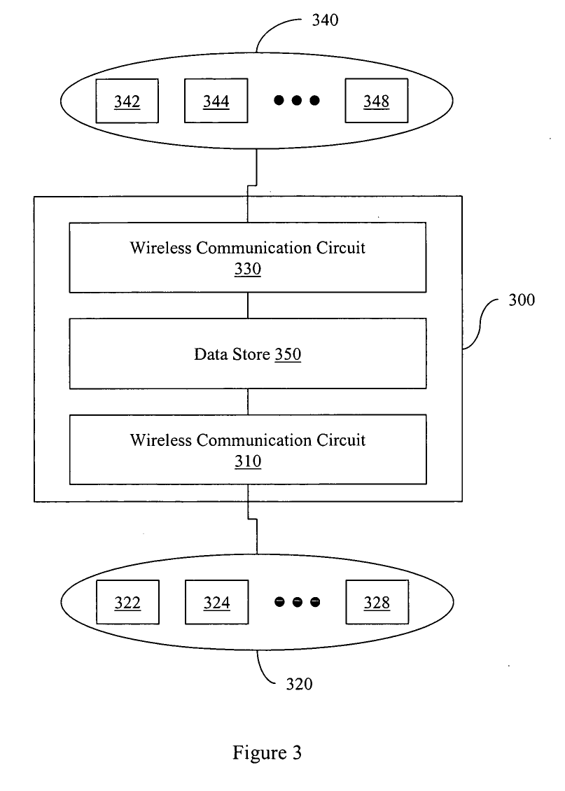

FIG. 3 illustrates a wireless hub and data store apparatus 300. The wireless hub 300 includes a first wireless communication circuit 310 that is configured to communicate at a range of no more than three meters with a personal electronic device(s) (e.g., 322, 324, . . . 328) on a very local area network (VLAN) 320. Communication circuit 310 may be, for example, a short range radio transceiver.

Apparatus 300 may also include a second wireless communication circuit 330 that is configured to communicate at a range of up to at least ten meters with a wireless communication device(s) (e.g., 342, 344, . . . 348) not on VLAN 320 but located on a separate network 340. Communication circuit 330 may be, for example, a longer range radio transceiver.

Apparatus 300 may also include a data store 350 that is operably connected to both the first wireless communication circuit 310 and to the second wireless communication circuit 330. The data store 350 may be configured to store data for a personal electronic device(s) on the VLAN 320. In one example, the data store 350 may be configured to store data that is unique to a personal electronic device in a first logical storage area(s) and to store data that is common to two or more personal electronic devices in a second logical storage area(s). Unique and shared data may be stored in different logical and/or physical areas to facilitate, for example, applying different security measures, applying synchronization techniques, and so on.

Certain shared data like a password or social security number may benefit from a heightened security level over other data like a public telephone number. Thus, data store 350 may be configured to provide a first security logic(s) for a first logical storage area(s) and to provide a second security logic(s) for the second logical storage area(s). The first security logic(s) and the second security logic(s) may employ different techniques, algorithms, circuits, and so on to provide different levels of security.

In one example, data store 350 may be configured as a relational database. The relational database may store, for example, songs (e.g., MP3 format), videos (e.g., MPEG format), email addresses, addresses, telephone numbers, personal identification data, and so on.

Some portions of the detailed descriptions that follow are presented in terms of algorithms and symbolic representations of operations on data bits within a memory. These are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and so on. Thus, the results may be a transitory physical change.

It has proven convenient at times, principally for reasons of common usage, to refer to the manipulated physical quantities as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, calculating, determining, displaying, and so on, refer to actions and processes of a computer system, logic, processor, or similar electronic device that manipulates and transforms data represented as physical (electronic) quantities.

Example methods may be better appreciated with reference to flow diagrams. While for purposes of simplicity of explanation, the illustrated methods are shown and described as a series of blocks, it is to be appreciated that the methods are not limited by the order of the blocks, as some blocks may occur in different orders and/or concurrently with other blocks from that shown and described. Moreover, less than all the illustrated blocks may be required to implement an example method, blocks may be combined or separated into multiple components, and additional and/or alternative methods may employ additional, not illustrated blocks. While the figures illustrate various actions occurring in serial, it is to be appreciated that in different examples various actions could occur concurrently, substantially in parallel, and/or at substantially different points in time.

The elements illustrated in the flow diagrams denote “processing blocks” that may be implemented in logic. In one example, the processing blocks may represent executable instructions that cause a computer, processor, and/or logic device to respond, to perform an action(s), to change states, and/or to make decisions. Thus, the described methods can be implemented as processor executable instructions and/or operations provided by a computer-readable medium. In another example, the processing blocks may represent functions and/or actions performed by functionally equivalent circuits such as an analog circuit, a digital signal processor circuit, an application specific integrated circuit (ASIC), or other logic device. Therefore, the diagrams illustrate functional information one skilled in the art could use to design/fabricate circuits, generate software, or use a combination of hardware and software to perform the illustrated processing.

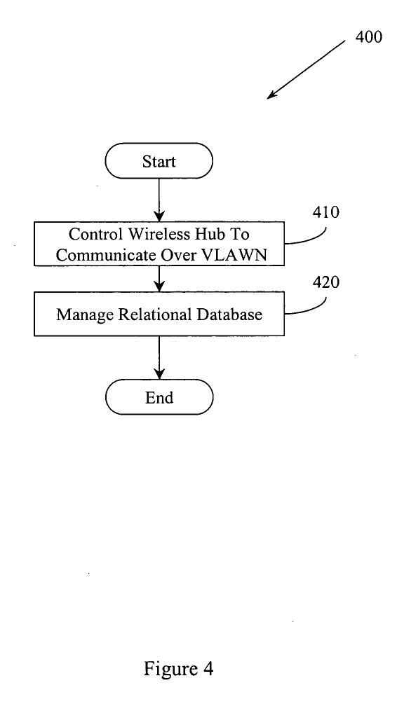

FIG. 4 illustrates a method 400 performable in a wireless hub. Method 400 may include, at 410, controlling a wireless hub to communicate with a personal computing device(s) over a very local area wireless network. Controlling the wireless hub to communicate may include, for example, controlling a wireless transmitter/receiver (transceiver), controlling a modulator/demodulator (modem), controlling a coder/decoder (codec), and so on. Controlling the wireless hub to communicate may also include, for example, providing control signals and managing state transitions associated with a communication protocol.

Method 400 may also include, at 420, managing on the wireless hub a relational database configured to store data for the personal computing device(s). Managing 420 the relational database may include creating a relational database table(s). With the table created, managing 420 may also include activities like receiving a request for stored data, retrieving the requested data, and providing it to the requesting device. Note that the wireless hub on which method 400 is performed may simply include communication circuits, memory, and logic to run the relational database. There may be no input/output devices (e.g., keyboard), no display unit (e.g., monitor), no audio unit (e.g., speaker) and so on. The input/output capability, audio capability, and display capability may all be provided by devices accessing the wireless hub. While conventional wireless hubs may provide communication, they have traditionally not provided the relational database capability. In one example, managing 420 the relational database may include sharing data between personal computing devices and maintaining synchronization for data shared between the personal computing devices.

While FIG. 4 illustrates various actions occurring in serial, it is to be appreciated that various actions illustrated in FIG. 4 could occur substantially in parallel. By way of illustration, a first process could control the wireless hub to communicate while a second process could manage the relational database. While two processes are described, it is to be appreciated that a greater and/or lesser number of processes could be employed and that lightweight processes, regular processes, threads, and other approaches could be employed.

In one example, methods are implemented as processor executable instructions and/or operations stored on a computer-readable medium. Thus, in one example, a computer-readable medium may store processor executable instructions operable to perform a method on a wireless hub. The method may include controlling a wireless hub to communicate with personal computing devices over a very local area wireless network. The method may also include controlling the wireless hub to manage a relational database, to secure data in the wireless hub, to share data between personal computing devices, and to maintain synchronization for data shared between personal computing devices. While the above method is described being stored on a computer-readable medium, it is to be appreciated that other example methods described herein may also be stored on a computer-readable medium.

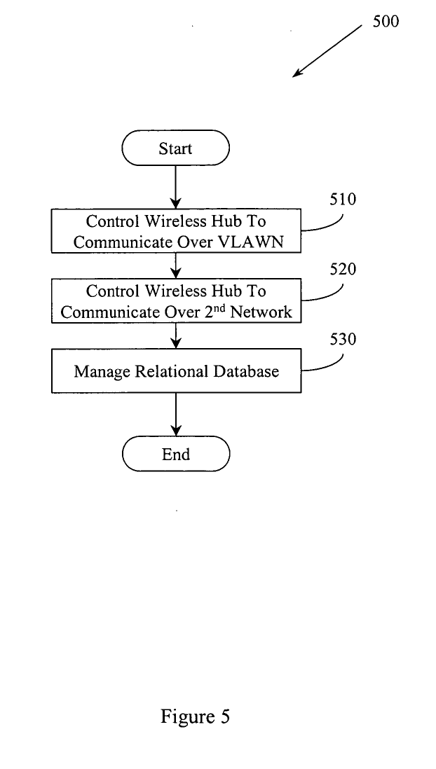

FIG. 5 illustrates a method 500 similar to method 400. For example, method 500 includes controlling 510 a wireless hub to communicate with personal computing devices over a very local area wireless network and managing 530 a relational database. Additionally, method 500 may include controlling 520 the wireless hub to communicate with a wireless computing device(s) over a second wireless network. With dual communication capability, parallel operations may be performed. For example, data for personal electronic devices may be retrieved from the second network while data is being provided to a personal electronic device or received from a personal electronic device over the very local area wireless network. This may facilitate improving performance for the personal electronic devices.

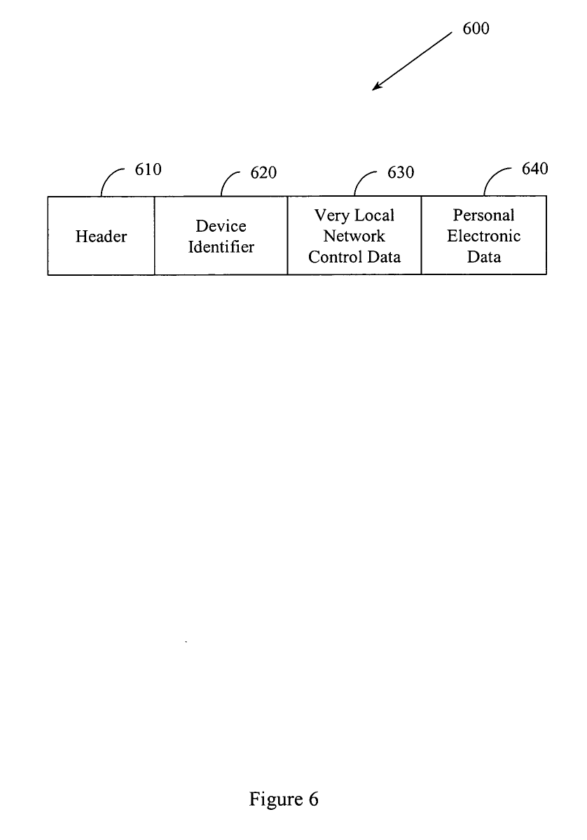

Referring now to FIG. 6, information can be transmitted between various computer components and/or logics associated with a personal wireless hub and data store as described herein via a data packet 600. The data packet 600 includes a header field 610 that includes information like the length and type of packet. A device identifier 620 follows the header field 610 and includes, for example, an address of the device from which the packet 600 originated. A device identifier can be, for example, a globally unique identifier (GUID), a uniform resource locator (URL), a path name, and so on. Following the device identifier 620, the packet 600 includes a very local network control data 630 that holds, for example, an address of the computer component and/or logic to which the packet 600 is ultimately destined and/or parameters concerning how the packet is to be delivered. Finally, data packet 600 may include a personal electronic data field 640. This field may store, for example, a song, a portion of a song, a video, a portion of a video, an address, an email address, a phone number, a purchase amount authority, and so on. While four fields are illustrated in a certain order, it is to be appreciated that a greater and/or lesser number of fields arranged in different orders can be present in example data packets.

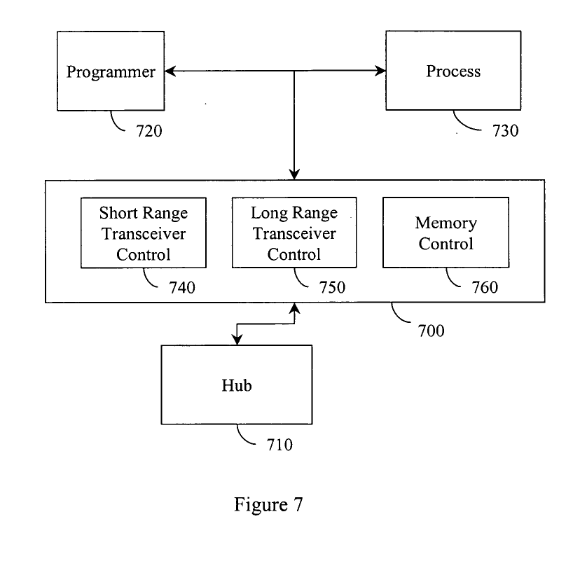

Referring now to FIG. 7, an application programming interface (API) 700 is illustrated providing access to a personal wireless hub 710. The API 700 can be employed, for example, by a programmer 720 and/or a process 730 to gain access to processing performed by the personal wireless hub 710. For example, a programmer 720 can write a program to access the personal wireless hub 710 (e.g., invoke its operation, monitor its operation, control its operation) where writing the program is facilitated by the presence of the API 700. Rather than programmer 720 having to understand the internals of the personal wireless hub 710, the programmer 720 merely has to learn the interface to the personal wireless hub 710. This facilitates encapsulating the functionality of the personal wireless hub 710 while exposing that functionality.

Similarly, the API 700 can be employed to provide data values to the personal wireless hub 710 and/or to retrieve data values from the personal wireless hub 710. For example, a process 730 that controls a short range transceiver can provide control data to the personal wireless hub 710 via the API 700 by, for example, using a call provided in the API 700.

In one example of API 700 a set of application programming interfaces can be stored on a computer-readable medium. The interfaces can be employed by a programmer, computer component, logic, and so on to gain access to a personal wireless hub 710. The interfaces can include, but are not limited to, a first interface 740 that communicates a short range transceiver control data, a second interface 750 that communicates a long range transceiver control data, and a third interface 760 that communicates a memory control data. The short range transceiver control data may include, for example, information for controlling a communication device that interacts with devices on a very local (e.g., <3 meter) wireless network. This control data may include timing information, protocol information, location information, synchronization information, and so on. The long range transceiver control data may include, for example, information for controlling a communication device (e.g., radio) that interacts with a device on a wider (e.g., >10 meter) wireless network. This control data may include timing information, protocol information, location information, synchronization information, and so on. The memory control data may include, for example, information for controlling how data is stored, secured, shared, and so on. While API 700 illustrates three interfaces, it is to be appreciated that in one example API 700 may only include the short range transceiver control interface 740 and the memory control data interface 760.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methods for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. An apparatus, comprising:
a memory configured to store application data for one or more electronic devices operating in a very local wireless network, the memory being located in a computing device separate from the electronic devices;
a data control logic operably connected to the memory, the data control logic being configured to receive application data from the electronic devices, to selectively provide application data to the memory, to manipulate application data stored in the memory, and to selectively provide application data stored in the memory to the electronic devices; and
a communication logic operably connected to the memory, the communication logic being configured to communicate application data between the computing device in which the memory is located and the electronic devices using the very local wireless network.

2. The apparatus of claim 1, the communication logic also being configured to communicate with a computing device not operating in the very local wireless network.

3. The apparatus of claim 1, the communication logic being configured to control a transceiver to communicate with the very local wireless network.

4. The apparatus of claim 1, the application data comprising cellular telephone data, personal digital assistant data, music, video, and contact data.

5. The apparatus of claim 1, the electronic devices including one or more of, a cellular telephone, a personal digital assistant, an MP3 player, and an MPEG player.

6. The apparatus of claim 2, the communication logic being configured to control a transceiver to communicate with a second wireless network on which the computing device not operating in the very local wireless network is operating.

7. The apparatus of claim 6, the very local wireless network operating at a range of less than two meters and with a power of less than 10 milliwatts.

8. The apparatus of claim 7, the second network operating at a range of more than 100 meters and with a power of more than 500 milliwatts.

9. The apparatus of claim 1, the data control logic being configured to manage a relational database and to manipulate application data stored in the memory as a portion of a relational database table.

10. The apparatus of claim 1, the data control logic being configured to manage application data stored in the memory to be shareable between two or more electronic devices on the very local wireless network and to be synchronized between two or more electronic devices on the very local wireless network.

11. The apparatus of claim 1, the data control logic being configured to implement a portion of a two-stage security procedure involving both the apparatus and an electronic device operating on the very local wireless network.

12. An apparatus, comprising:
a memory configured to store application data for one or more electronic devices operating in a very local wireless network, the memory being located in a computing device separate from the electronic devices, the electronic devices including one or more of, a cellular telephone, a personal digital assistant, an MP3 player, and an MPEG player, the application data comprising one or more of, cellular telephone data, personal digital assistant data, music, video, and contact data;
a data control logic operably connected to the memory, the data control logic being configured to receive application data from the electronic devices, to selectively provide application data to the memory, to manipulate application data stored in the memory, to selectively provide application data stored in the memory to the electronic devices, to manage a relational database table, to manipulate application data stored in the memory as a portion of the relational database table, to manage application data stored in the memory to be shareable between two or more electronic devices on the very local wireless network, and to manage application data stored in the memory to be synchronized between two or more electronic devices on the very local wireless network; and
a communication logic operably connected to the memory, the communication logic being configured to communicate application data between the computing device in which the memory is located and the electronic devices using the very local wireless network, the communication logic being configured to communicate with a computing device not operating in the very local wireless network, the communication logic being configured to control a transceiver to communicate with the very local wireless network, the communication logic being configured to control a transceiver to communicate with a second wireless network on which the computing device not operating in the very local wireless network is operating;
the very local wireless network operating at a range of less than two meters and with a power of less than 10 milliwatts;
the second wireless network operating at a range of more than 100 meters and with a power of more than 500 milliwatts.

13. A wireless hub and data store apparatus, comprising:
a first wireless communication circuit configured to communicate at a range of no more than three meters with one or more personal electronic devices on a very local area network (VLAN);
a second wireless communication circuit configured to communicate at a range of up to at least ten meters with one or more wireless communication devices not on the VLAN; and
a data store operably connected to the first wireless communication circuit and the second wireless communication circuit, the data store being configured to store data for one or more of the personal electronic devices on the VLAN.

14. The apparatus of claim 13, the data store being configured to store data that is unique to a personal electronic device in one or more first logical storage areas and to store data that is common to two or more personal electronic devices in a second logical storage area.

15. The apparatus of claim 14, the data store being configured to provide one or more first security logics for the one or more first logical storage areas and to provide a second security logic for the second logical storage area.

16. The apparatus of claim 13, the data store being configured as a relational database.

17. The apparatus of claim 13, the data including songs, videos, email addresses, addresses, telephone numbers, and personal identification data.

18. A method, comprising:
controlling a wireless hub to communicate with one or more personal computing devices over a very local area wireless network; and
managing, on the wireless hub, a relational database configured to store data for one or more of the personal computing devices;
the method being performed on the wireless hub.

19. The method of claim 18, where managing the relational database includes creating one or more relational database tables.

20. The method of claim 19, where managing the relational database includes securing data in the relational database, sharing data between two or more personal computing devices, and maintaining synchronization for data shared between two or more personal computing devices.

21. The method of claim 18, including controlling the wireless hub to communicate with one or more wireless computing devices over a second wireless network.

22. A computer-readable medium storing processor executable instructions operable to perform a method on a wireless hub, the method comprising:
controlling a wireless hub to communicate with one or more personal computing devices over a very local area wireless network;
controlling the wireless hub to communicate with one or more wireless computing devices over a second wireless network; and
controlling the wireless hub to perform one or more of, managing a relational database, securing data in the wireless hub, sharing data between two or more personal computing devices, and maintaining synchronization for data shared between two or more personal computing devices.

23. A system, comprising:
means for remotely storing data for one or more wireless electronic apparatus connected to a very local area wireless network;
means for managing data stored in the means for storing; and
means for communicating with the one or more wireless electronic apparatus.

24. A data packet for communicating personal electronic data between a personal computing apparatus and a personal wireless hub, comprising:
a first field that stores a device identifier;
a second field that stores a very local area network control data; and
a third field that stores personal electronic data.

25. A set of application programming interfaces embodied on a computer-readable medium for execution by a computer component in conjunction with managing data and managing data communications for a short range wireless hub, comprising:
a first interface for communicating a short range transceiver control data; and
a second interface for communicating a memory control data for a memory operably connected to the short range transceiver.
